(19) United States
(12) Patent Application Publication
(10) Pub. No.: US 2025/0115158 A1
(43) Pub. Date: Apr. 10, 2025

(54) ROAD CONSTRUCTION MACHINE WITH ELECTRIC DRIVE

(71) Applicant: JOSEPH VÖGELE AG, Ludwigshafen/Rhein (DE)

(72) Inventors: Steffen KOST, Bad Dürkheim (DE); Achim EUL, Mannheim (DE); Bernhard ERDTMANN, Edingen Neckarhausen (DE); Johannes PONTIUS, Schmelz (DE)

(73) Assignee: JOSEPH VÖGELE AG, Ludwigshafen/Rhein (DE)

(21) Appl. No.: 18/897,410

(22) Filed: Sep. 26, 2024

(30) Foreign Application Priority Data
Oct. 6, 2023 (EP) 23202080.0

(51) Int. Cl. B60L 58/12

(52) U.S. Cl. CPC B60L 58/12; B60L 2200/40; B60L 2250/16

(57) ABSTRACT

A road construction machine includes an electric drive, a rechargeable battery for supplying the electric drive with electric current, a charging device for connecting the rechargeable battery to an external current source and for charging the rechargeable battery, and a display device for displaying information indicative of a charge state of the rechargeable battery and/or information indicative of a charging process of the rechargeable battery.

### CROSS-REFERENCE TO RELATED APPLICATIONS

This application claims foreign priority benefits under 35 U.S.C. § 119(a)-(d) to European patent application number EP 23202080.0, filed Oct. 6, 2023, which is incorporated by reference in its entirety.

### TECHNICAL FIELD

The present disclosure relates to a road construction machine with an electric drive and to a method for monitoring and/or controlling a road construction machine.

### BACKGROUND

Road construction machines are well known from the prior art. These include road pavers that spread construction material onto a road to be paved and, for example, use a paving screed to finish the road surface. Feeders are also known that can feed a hopper of a road paver with construction material. Other machines or vehicles, such as bulldozers, are also known that can be used to build the road.

Road construction machines usually include combustion engines to provide the power required for their work and movement. Alternatively, however, configurations are also known in which an electric drive can be used either in addition to the combustion engine or as the sole energy source of the road construction machine.

Road construction machines with at least partial electric drive, however, require electrical energy that can be stored in a rechargeable battery of the road construction machine in order to perform their work. This energy usually has to be supplied to the rechargeable battery over longer charging cycles, which means that the use of such a road construction machine requires a higher planning effort with regard to its use, as the necessary charging cycles are longer than the time required to refill fossil fuels.

### SUMMARY

Based on the known prior art, a technical problem to be solved is thus to provide a road construction machine and a method for monitoring and/or controlling a road construction machine which simplifies the use of the road construction machine.

This problem is solved by a road construction machine with an electric drive according to the disclosure and a method for monitoring and/or controlling a road construction machine with an electric drive according to the disclosure. Preferred further embodiments of according to the disclosure are also provided.

According to the disclosure, a road construction machine is provided, the road construction machine comprising an electric drive, a rechargeable battery for supplying the electric drive with electric current, a charging device for connecting the rechargeable battery to an external current source and for charging the rechargeable battery, and a display device for displaying information indicative of a charge state of the rechargeable battery and/or information indicative of a charging process of the rechargeable battery.

The information indicative of the charge state of the rechargeable battery may preferably include an indication of the energy content of the rechargeable battery. The information indicative of the charging process of the rechargeable battery may in particular comprise information indicative of the correct functioning of the charging of the rechargeable battery and/or further information on the charging process, such as certain conditions for the charging process predetermined by an operator of the road construction machine. However, the disclosure is not limited in this respect. It is preferred if the indicative information on the display device is in particular information that does not merely contain or reproduce binary information (charging process running or not running), but contains technical data on the charge state and/or charging process, which is preferably reproduced in an alphanumeric format.

In particular, information that is indicative of the charging process and/or the charge state in the form of parameter values can be output as absolute values and/or as relative values in relation to a predefined reference value. For example, the charge state and in particular the energy content of the rechargeable battery during charging can be output as an absolute value in the form of kWh or kJ, for example, or in relation to the maximum charge or the energy content of the rechargeable battery as a percentage. A combined display of absolute values and relative values is also possible.

With this road construction machine, the current status of the rechargeable battery and/or charging process is displayed to an operator in a simple manner, so that the operator can better plan or anticipate the operation of the road construction machine. This facilitates the operation of the road construction machine.

It may be provided that the display device is arranged at a distance of at most 1 m or at most 0.5 m from a connection of the charging device for connecting the rechargeable battery to an external current source on the road construction machine.

The display device in this case is arranged such that it is preferably accessible or visible to the operator at all times. This allows the operator to recognize the information indicative of the charging process and/or charge state while operating the charging device. This makes it easier for the operator, for example, to operate the charging process by connecting or removing a corresponding plug to start or end the charging process and reduces the distances the operator has to cover.

In one embodiment, the information indicative of the charge state of the rechargeable battery comprises at least one of an absolute and/or relative charge state of the rechargeable battery, an actual energy content in relation to a target maximum energy content of the rechargeable battery. The operator can use this display to easily recognize the charge state of the rechargeable battery and determine, for example, whether the road construction machine can be used for the intended work without completing the charging process (or charging the rechargeable battery to 100%). This can improve the use of the road construction machine.

The information indicative of the charging process of the rechargeable battery may include at least one of information about a start of the charging process, a complete completion of the charging process, an error during the charging process. This allows the operator to determine whether the charging process is proceeding as planned.

It may be provided that the display device is adapted to output the information indicative of the charging process of the rechargeable battery in an alphanumeric format. The alphanumeric format can include letters and/or numbers as well as special characters and optionally also include a pictographic illustration that depicts the alphanumeric information pictographically. This can facilitate the operator's understanding.

The information indicative of the rechargeable battery charging process may include at least one of a charging efficiency, a battery temperature, an estimated charging time, a battery status, a connection status, a charging current. This allows the use of the road construction machine to be better planned.

It may be provided that the road construction machine comprises an input device for interaction of an operator with the display device and/or for setting a function of the road construction machine.

The input device can, for example, be configured in the form of a keyboard or comprise one. Alternatively or additionally, the display device can be configured as a touchpad, so that the display device and the input device are integrated in one device.

The function of the road construction machine can be any function of the road construction machine. In particular, this includes functions that can be used for building or processing road surfaces, but other functions, such as lighting or heating a driver's cab of the road construction machine, are also included under the term road construction machine. Functions relating to the charging process are also included. The input device provides the operator with a possibility to influence the operation of the road construction machine, also taking into account the charging process.

The function can include a time control of the charging process and/or a charging mode and/or a target charge state of the rechargeable battery. A time control of the charging process is to be understood in particular in such a way that a start time and/or an end time for the charging process can be defined, which is, for example, independent of the charge state of the rechargeable battery reached at that time and determines a start and/or end of the charging process so that it can be started and/or ended without further interaction with the operator after connection to the external current source. This simplifies the operation of the road construction machine. The charging mode can, for example, include fast charging of the rechargeable battery with increased energy consumption or normal charging with lower energy consumption and thus longer charging time, but preferably gentler charging of the rechargeable battery or battery cells. A desired energy content (as an absolute value or relative value in relation to a maximum energy content) can be provided as the target charge state. The charging process can then be terminated automatically when the target charge state is reached or when the target charge state is reached with a certain tolerance (e.g., 1% or 2% or 5% deviation). In this way, the charging of the rechargeable battery can be easily set by the operator depending on the desired use of the road construction machine, for example, resulting in a more flexible use of the road construction machine.

It may be provided that the function comprises an operating mode of at least one working component of the road construction machine during the charging process. The working component may, for example, be a paving screed of a road paver. The operating mode during the charging process can include, for example, preheating or heating the paving screed to a desired operating temperature so that the road paver is immediately ready for use at the end of the charging process. However, any other working component of a road construction machine is also conceivable here. With this embodiment, the road construction machine can be used more efficiently.

The road construction machine may further comprise a control unit for controlling the working component depending on the set operating mode. The control unit may be configured as a computer with an associated processor and memory and may, for example, comprise program instructions which enable the working component to be controlled depending on the operating mode set by an operator. For this purpose, for example, each operating mode can be assigned operating parameters of the working component, which are used by the control unit to control the working component depending on the selected operating mode. This reduces the number of operator interventions required to control the road construction machine, making it easier to use.

The road construction machine can be adapted as a road paver or a feeder vehicle or a combined road paver-feeder-construction train. These vehicles can particularly preferably be equipped with an electric drive (for example realized as a hybrid vehicle as an addition to an internal combustion engine) or a purely electric drive.

The road construction machine can include an internal combustion engine. In this sense, the road construction machine can be configured with a “hybrid drive”. This allows the road construction machine to be used more flexibly.

According to the disclosure, a method for monitoring and/or controlling a road construction machine is provided, wherein the road construction machine comprises an electric drive, a rechargeable battery for supplying the electric drive with electric current, a charging device for connecting the rechargeable battery to an external current source and for charging the rechargeable battery, and wherein the road construction machine further comprises a display device for displaying information indicative of a charge state of the rechargeable battery and/or information indicative of a charging process of the rechargeable battery, the method comprising displaying the indicative information on the display device. This method allows improved monitoring and control of the road construction machine for the operator, even during longer charging cycles of the rechargeable battery, which improves the usability of the road construction machine.

In the context of the method, the road construction machine may be a road construction machine according to one of the preceding embodiments. The advantages of the road construction machine described above can be realized in operation with this embodiment.

The method can include controlling a working component of the road construction machine depending on an operating mode of the working component set via an input device during the charging process. This can ensure that the road construction machine can be used when the charging process is complete.

All of the embodiments described are disclosed as being combinable with one another as desired.

### BRIEF DESCRIPTION OF THE DRAWINGS

FIG. 1 shows a schematic view of a road construction machine according to one embodiment; and

FIG. 2 shows a schematic view of a charging device and a display device according to one embodiment.

### DETAILED DESCRIPTION

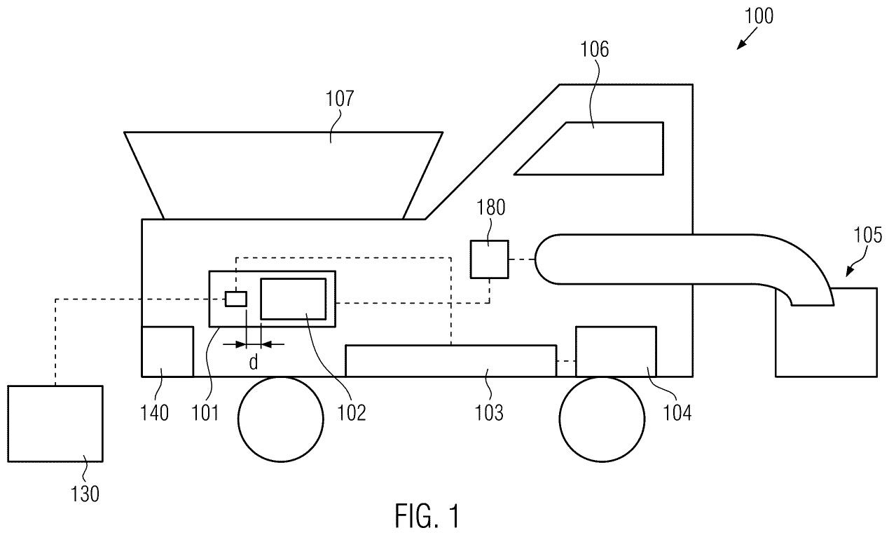

FIG. 1 shows a road construction machine 100 according to an embodiment of the present disclosure. The road construction machine is shown here as a road paver comprising a paving screed 105 for discharging heated construction material, which can be fed to the paving screed via the hopper 107 shown as an example. However, the embodiment of the road construction machine 100 as a road paver is not mandatory. The road construction machine 100 may also be configured as a feeder or any other machine used in the context of road construction, in particular a mobile machine, and may also or alternatively comprise, for example, a bulldozer or be realized as a (combined) vehicle train comprising a road paver and a feeder and/or comprising other or further vehicles or machines.

The road construction machine 100 may or may not, however, include a driver's cab 106 from which an operator can at least partially control and/or monitor the operation of the road construction machine.

According to the disclosure, the road construction machine 100 comprises an electric drive 104 (e.g., electric motor, electric actuator, etc.) for operating at least one component of the road construction machine (such as the paving screed 105) and/or the entire road construction machine (for example including drive elements for moving the road construction machine, such as wheels or chains) and a rechargeable battery 103 for supplying the electric drive 104 with electric current. Furthermore, the road construction machine 100 comprises a charging device 101 for connecting the rechargeable battery 103 to an external current source 130. The external current source is not limited according to the disclosure and may be, for example, a connection to a municipal or generally available power grid. The charging device 101 can be connected thereto, for example via a suitable cable, in order to supply electrical energy in the form of current to the rechargeable battery 103 for charging the rechargeable battery.

Optionally, in addition to the electric drive 104, the road construction machine may include an internal combustion engine 140 to at least partially supply the road construction machine with energy. The internal combustion engine 140 may also be provided as a backup and only be used when the rechargeable battery level is too low to maintain the function of the road construction machine.

Furthermore, according to the disclosure, a display device 102 is provided as part of the road construction machine 100, via which indicative information can be displayed for the charge state of the rechargeable battery 103 and/or for the charging process of the rechargeable battery 103.

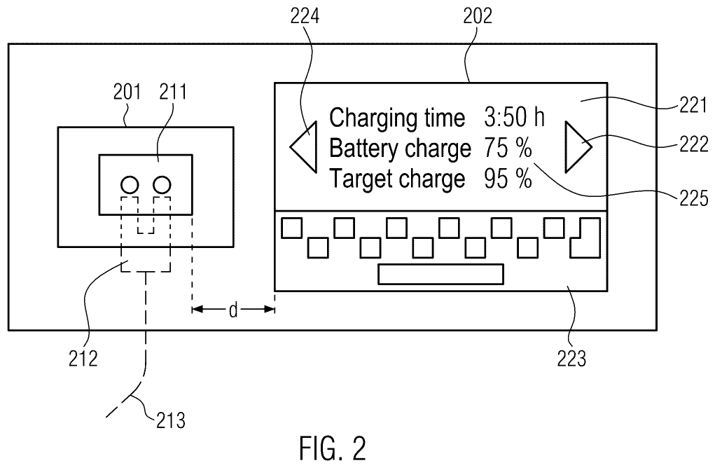

The display device 102 can in principle be arranged at any position of the road construction machine 100, as long as this position is accessible to an operator, so that an operator can perceive the information displayed on the display device. Preferably, the display device 102 can be arranged in a driver's cab 106 (if provided) of the road construction machine 100 or can be provided in an area in the vicinity of the charging device 101 or a connection (see FIG. 2) of the charging device. The area can be selected such that a distance d of the display device to the charging device or the connection of the charging device is at most 1 meter (m) or at most 0.5 m, particularly preferably at most 0.25 m. The display device is thus arranged in the immediate vicinity of the charging device, which can simplify the operation of the charging device by an operator, for example also based on the indicative information displayed.

However, the distance d (see FIG. 1) can basically be chosen as desired and does not have to extend in a horizontal direction, as shown here, but can also run vertically or at least partially vertically, so that the display device can also be arranged above or below the connection or the charging device or offset at an angle to it.

Preferably, the display device and/or the charging device are arranged such that ergonomic access for an operator is possible, in particular without the operator having to bend down or squat. For example, the connection and/or the charging device can be arranged at a height of between 1 m and 1.5 m measured from the bottom when the road construction machine is standing on the ground and/or the display device can be arranged at a height of between 1.3 m and 1.9 m measured from the bottom.

The road construction machine 100 may further comprise a control unit 180, which may be connected to the charging device 101 and/or the display device 102, and may control a working component 105 (for example, the paving screed) based on, for example, an input to the display device 102 or an associated input device.

The information displayed on the display device, which is indicative of the charge state of the rechargeable battery and/or the charging process, can preferably be displayed in an alphanumeric format, which may comprise letters and/or digits and/or other special characters. For example, parameters that define or are characteristic of the charging process and/or the charge state can be indicated in the form of absolute values or relative values in relation to a reference variable.

For example, the energy content of the rechargeable battery can be displayed on the display device as an indicator of the charge state. This can be indicated, for example, as the “actual energy content” in kWh or in kJ (absolute value) and/or as a relative value (for example as a percentage or a value between 0 and 1) in relation to a target maximum energy content of the rechargeable battery. The target maximum energy content of the rechargeable battery can either be the maximum energy content of the rechargeable battery or a desired target maximum energy content of the rechargeable battery, which is to be achieved at the end of the charging process, for example.

A temperature of the rechargeable battery during the charging process can also be displayed as indicative information for the charging process and output in degrees Celsius, for example. A sensor not shown here can be provided for this purpose, which can measure the temperature of the rechargeable battery or a part thereof and transfer this information to the control unit 180. The control unit 180 can then optionally process the measured temperature and, if necessary, output/display it on the display unit together with other information. This enables the operator to determine whether the charging process is running reliably. In addition to the temperature of the rechargeable battery, a pictographic illustration can be displayed, for example in the form of a colored symbol, which is indicative of whether the temperature of the rechargeable battery is within a permissible range during the charging process. This permissible range can be defined, for example, by a minimum and/or maximum temperature of the rechargeable battery during a charging process and can be determined by the structure of the rechargeable battery.

Further information indicative of the rechargeable battery charging process may include, for example, a start or end of the charging process and a charging process error. In the event of an error during the charging process, for example, incorrect insertion of a plug (see FIG. 2) can be displayed and the operator can optionally be instructed to check the position of the plug by a corresponding output on the display device.

Furthermore, detailed messages can be issued about any errors that occur during the charging process (for example, if the permissible rechargeable battery temperature is exceeded or if an error occurs when supplying energy to the rechargeable battery).

Additionally or alternatively, indicative information can be displayed for the charging process, for example indicating a charging efficiency (as a percentage relative to a maximum charging efficiency that can be achieved, for example in terms of structure, or as an absolute value in the form of an efficiency). Additionally or alternatively, an actual charging current that is transferred from the charging device to the rechargeable battery and/or that is transferred from the external current source 130 to the charging device can also be displayed. In order to determine this charging current, for example, a voltmeter and/or ammeter can be provided in the road construction machine in conjunction with the charging device 101 and/or the rechargeable battery 103, which can measure the voltage applied to the rechargeable battery and/or the charging device or the current transmitted to the rechargeable battery or the charging device. The information from the ammeter or voltmeter can then be transferred, for example, to the control unit 180, which can process this information further if necessary and transfer it to the display device for display.

Furthermore (additionally or alternatively), the information indicative of the charging process displayed on the display device 102 may also include an estimated charging time, for example until the maximum charge level (energy content) of the rechargeable battery is reached and/or until a desired charge level of the rechargeable battery is reached. Additionally or alternatively, information can also be displayed, for example, about how long the charging process is already taking or which charging mode is being used. The rechargeable battery can thus be displayed with different charging modes, for example a fast charging mode, in which a comparatively large amount of energy is transferred to the rechargeable battery in a given unit of time, and a normal charging mode, in which a smaller amount of energy is transferred to the rechargeable battery in the same unit of time and at the same time charging places less physical strain on the rechargeable battery.

The selected charging mode can also be displayed on the display device not only in alphanumeric format, for example, but also in the form of a pictographic illustration to make it easier for the operator to recognize the selected charging mode. It may also be provided that a pictographic illustration of the charging mode itself is displayed together with other information indicative of the charging mode (for example, amount of energy supplied per unit of time) displayed in an alphanumeric format. The operator is thus informed of the conditions under which the rechargeable battery is being charged. Additionally or alternatively, information can also be displayed about when the desired energy content and/or the maximum energy content of the rechargeable battery will be reached when the relevant charging mode is used.

FIG. 2 shows a further embodiment of the charging device 201 and the display device 202. In the embodiment shown here, the charging device 201 is shown only by way of example as comprising a connection 211. This embodiment can also be realized with any of the embodiments described in conjunction with FIG. 1. The connection 201 can be configured such that it can be detachably connected via a plug 212 and with a suitable cable 213 to the external current source not shown here (for example the current source 130 of FIG. 1). In addition, a protective device (not shown) can be provided here, which can prevent the plug from accidentally falling out or being released from the connection and thus interrupting the charging process. This protective device may be mechanical and may, for example, comprise one or more terminals that firmly connect the plug to the connection 211 and can only be released by manual actuation. This ensures that the charging process runs reliably.

In FIG. 2, the display device 202 is also shown in an area next to the connection 211 (at a distance d, as described in FIG. 1). While here the display device 202 is arranged to the right of the connection 211, this configuration, as already described, is not mandatory. Alternatively, the display device 202 can also be arranged to the left of the connection 211 or above or below the connection 211 or offset at an angle thereto. The disclosure is not limited in this respect and the embodiments described in conjunction with FIG. 1 can also be realized here.

In the embodiment shown in FIG. 2, the display device 202 comprises a display area 221 in which the information 225 indicative of the charging process and/or charge state is displayed. In this context, individual pieces of information or also groups of information that are indicative of different parameters or states during the charging process and/or the charge state of the rechargeable battery can be displayed together. In the embodiment shown here, for example, a remaining charging time is displayed (here, for example, as 3 hours and 50 minutes). This remaining charging time can, for example, be calculated by the control unit 180 already described in FIG. 1 based on the amount of energy supplied to the rechargeable battery per unit of time and a target or intended maximum energy content of the rechargeable battery at the end of the charging process, wherein the target maximum energy content can correspond either to the maximum energy content of the rechargeable battery or to a desired energy content of the rechargeable battery at the end of the charging process.

Furthermore, in this embodiment, the actual energy content of the rechargeable battery (battery charge) is indicated as a relative value in relation to the maximum charge of the rechargeable battery. The target maximum energy content (target charge) is also specified as a relative value in relation to the maximum energy content of the rechargeable battery. Alternatively or additionally, absolute values can also be specified here, which indicate the respective energy content in kWh or kJ, for example. This information is only to be understood as an example and all of the information described so far and in the following can be shown on the display device instead or in addition.

In the embodiment shown here, the display device 202 optionally further comprises an input device 223. This may be provided as an additional keyboard, which may be provided separately from the display area 221. Alternatively, it may also be provided that the display device is configured in the form of an interactive touch display, so that the input device 223 and the display area 221 are integrated. This allows a targeted display of input elements for interaction with the operator depending on the information displayed.

Additionally or alternatively, it may be provided that switching elements 222 and 224 can be used to switch between different displays. For example, a first display can be provided that only outputs information on the charge state of the rechargeable battery. A second display, which can be called up by actuating the switching elements 222 and/or 224, can exclusively comprise information about the charging process. It is also possible to display subgroups of information indicative of the charge state and/or the charging process by actuating the switching elements 222 and/or 224.

The input device can also be used to provide the operator with a possibility to control a function of the road construction machine and/or a function of the charging process. For example, a charging mode (fast charging or normal charging as described above) can be selected via the input device 223 in order to carry out a charging process. Alternatively or additionally, it may be provided that the operator defines, for example, a target maximum energy content or an intended energy content at the end of the charging process via the input device 223 and the control unit 180 (see FIG. 1) then controls the charging process so that it is terminated when the intended energy content is reached. Alternatively or additionally, a charging duration for charging the rechargeable battery can also be specified by the operator via the input device 223. For example, this charging duration can be specified by the operator in hours and/or minutes and, if necessary, the charging process can be terminated independently of the charge level then reached.

Alternatively or additionally, it may also be provided that a function of the road construction machine can be set via the input device, which in particular comprises an operating mode of a working component of the road construction machine during the charging process. Using the example of a paving screed, this function can include, for example, preheating the paving screed to a desired operating temperature at the end of the charging process. If this operating mode of the working component is entered by an operator, the control unit 180 can supply the working component with energy via the rechargeable battery during the charging process in order to ensure the desired state of the working component at the end of the charging process. This ensures that the working component assumes the operating mode without having to draw energy from a rechargeable battery that is not connected to the current source, so that at the end of the charging process the working component assumes the desired operating state or operating mode and the rechargeable battery additionally has the desired energy content, for example. This ensures efficient operation of the road construction machine.

All the information described here, which is indicative of the charging process and/or the charge state of the road construction machine, can be displayed in any combination on the display device. This includes not only the joint display of the information on the display device, but also a selective display of the relevant information, between which it is possible to switch in accordance with the embodiments described in conjunction with FIG. 2.

As one skilled in the art would understand, the charging device 101, the display device 102, the control system 180, as well an any other system, unit, controller, machine, apparatus, element, sensor, detector, device, component, subsystem, arrangement, or the like described herein may individually, collectively, or in any combination comprise appropriate circuitry, such as one or more appropriately programmed processors (e.g., one or more microprocessors including central processing units (CPU)) and associated memory which may include stored operating system software and/or application software executable by the processor(s) for controlling operation thereof and/or for performing the particular algorithms represented by the various functions and/or operations described herein, including interaction and/or cooperation between any such charging device 101, display device 102, control system 180, system, unit, controller, machine, apparatus, element, sensor, detector, device, component, subsystem, arrangement, or the like. One or more of such processors, as well as other circuitry and/or hardware, may be included in a single component (e.g., an ASIC (Application-Specific Integrated Circuit)), or several processors and various circuitry and/or hardware may be distributed among several separate components, whether individually packaged or assembled into a SoC (System-on-a-Chip).

What is claimed is:

1. A road construction machine comprising an electric drive, a rechargeable battery for supplying the electric drive with electric current, a charging device for connecting the rechargeable battery to an external current source and for charging the rechargeable battery, and a display device for displaying information indicative of a charge state of the rechargeable battery and/or information indicative of a charging process of the rechargeable battery.

2. The road construction machine according to claim 1, wherein the display device is arranged at a distance of at most 1 meter from a connection of the charging device for connecting the rechargeable battery to the external current source.

3. The road construction machine according to claim 2, wherein the display device is arranged at most 0.5 meter from the connection of the charging device.

4. The road construction machine according to claim 1, wherein the information indicative of the charge state of the rechargeable battery comprises at least one of an absolute charge level of the rechargeable battery, a relative charge level of the rechargeable battery, or an actual energy content in relation to a target maximum energy content of the rechargeable battery.

5. The road construction machine according to claim 1, wherein the information indicative of the charging process of the rechargeable battery comprises at least one of an information about a start of the charging process, a complete completion of the charging process, or an error during the charging process.

6. The road construction machine according to claim 5, wherein the display device is adapted to output the information indicative of the charging process of the rechargeable battery in an alphanumeric format.

7. The road construction machine according to claim 1, wherein the information indicative of the charging process of the rechargeable battery comprises at least one of a charging efficiency, a battery temperature, an estimated charging time, a battery status, a connection status, or a charging current.

8. The road construction machine according to claim 1, wherein the road construction machine comprises an input device for allowing interaction of an operator with the display device and/or for setting a function of the road construction machine.

9. The road construction machine according to claim 8, wherein the function comprises a time control of the charging process and/or a charging mode and/or a target charge state of the rechargeable battery.

10. The road construction machine according to claim 8, wherein the function comprises an operating mode of a working component of the road construction machine during the charging process.

11. The road construction machine according to claim 10, further comprising a control unit for controlling the working component depending on the set operating mode.

12. The road construction machine according to claim 1, wherein the road construction machine is a road paver or a feeder vehicle or a combined road paver-feeder-construction train.

13. The road construction machine according to claim 1, wherein the road construction machine further comprises an internal combustion engine.

14. A method for monitoring and/or controlling a road construction machine, wherein the road construction machine comprises an electric drive, a rechargeable battery for supplying the electric drive with electric current, a charging device for connecting the rechargeable battery to an external current source and for charging the rechargeable battery, and a display device for displaying information indicative of a charge state of the rechargeable battery and/or information indicative of a charging process of the rechargeable battery, the method comprising displaying the information indicative of the charge state and/or the charging process on the display device.

15. The method according to claim 14, wherein the display device is arranged at a distance of at most 1 meter from a connection of the charging device for connecting the rechargeable battery to the external current source.

16. The method according to claim 14, further comprising controlling a working component of the road construction machine depending on an operating mode of the working component set via an input device during the charging process.
